(19) United States
(12) Patent Application Publication
(10) Pub. No.: US 2008/0318480 A1
(43) Pub. Date: Dec. 25, 2008

(54) Electrical connection sheet having a frame embedded in an elastic insulator

(75) Inventors: Takuo Sasaki, Tokyo (JP); Takayuki Nishimura, Tokyo (JP); Tatsuo Kimura, Tokyo (JP)

Correspondence Address: COLLARD & ROE, P.C., 1077 NORTHERN BOULEVARD, ROSLYN, NY, 11576, US

(73) Assignee: Japan Aviation Electronics Industry, Limited

(21) Appl. No.: 11/903,307

(22) Filed: Sep. 21, 2007

(30) Foreign Application Priority Data
Jun. 21, 2007 (JP) 2007-163585

(51) Int. Cl. H01R 13/46

(52) U.S. Cl. 439/625

(57) ABSTRACT

An electrical connection sheet includes a plate-like elastic insulator having a first and a second principal surface which are spaced from each other in a predetermined direction. Columnar elastic conductors penetrate a center portion of the elastic insulator to protrude from the first and the second principal surfaces. A frame is embedded in a peripheral portion of the elastic insulator and extends along the peripheral portion.

This application is based upon and claims the benefit of priority from Japanese patent application No. 2007-163585, filed on Jun. 21, 2007, the disclosure of which is incorporated herein in its entirety by reference.

### BACKGROUND OF THE INVENTION

This invention relates to an electrical connection sheet disposed or interposed between connection objects for electrically connecting electrodes of the connection objects to each other.

An electrical connection sheet of the type is disclosed, for example, in Japanese Unexamined Patent Application Publication (JP-A) No. 2006-24580 or Japanese Patent (JP-B2) No. 3767333. The electrical connection sheet comprises a plate-like elastic insulator, a plurality of conductors penetrating the elastic insulator, and a plate-like frame extending along an outer peripheral surface of the elastic insulator to surround the conductors. The frame serves to prevent the conductors from becoming eccentric or decentered in position because of elasticity of the elastic insulator.

Each conductor has opposite end portions exposed on upper and lower surfaces of the elastic insulator. The frame is attached to the elastic insulator in a manner such that its inner end bites into an outer peripheral portion adjacent to the outer peripheral surface of the elastic insulator. In order to prevent the elastic insulator from being released from the frame, the frame may preliminarily be provided with a primer layer formed on each of opposite surfaces thereof before the frame is attached to the elastic insulator.

The electrical connection sheet is cleaned prior to mounting in order to remove fat and oil on a surface of the sheet, which may otherwise cause contact failure. As a cleaner, ethanol is generally used. However, the primer layer may be dissolved in ethanol so that separation may be caused at an interface between the elastic insulator and the frame.

Even if ethanol is not used, another problem may arise. Specifically, if the interface communicates with ambient air, humidity or moisture in the atmosphere may excessively pass to the interface. In a bad environment, it is highly possible, on a long-term basis, that adhesion between the elastic insulator and the frame is decreased or weakened.

### SUMMARY OF THE INVENTION

It is therefore an exemplary object of this invention to provide an electrical connection sheet having a structure in which an interface between a frame and an elastic insulator is prevented from being contacted with or exposed to a cleaner or ambient air.

Other objects of the present invention will become clear as the description proceeds.

According to an exemplary aspect of the present invention, there is provided an electrical connection sheet comprising an elastic insulator being of a plate-like and having a first and a second principal surface which are spaced from each other in a predetermined direction, the elastic insulator comprising a center portion and a peripheral portion around the center portion. The electrical connection sheet further comprises a plurality of elastic conductors each being columnar and penetrating the center portion to protrude from the first and the second principal surfaces and a frame embedded in the peripheral portion and extending along the peripheral portion.

### BRIEF DESCRIPTION OF THE DRAWINGS

FIG. 1A is a plan view of an electrical connection sheet according to a first exemplary embodiment of this invention;

FIG. 1B is a sectional view taken along a line Ib-Ib in FIG. 1A;

FIGS. 2A and 2B are sectional views for describing a mounted state of the electrical connection sheet illustrated in FIGS. 1A and 1B;

FIG. 3A is a plan view of an electrical connection sheet according to a second exemplary embodiment of this invention;

FIG. 3B is a sectional view taken along a line IIIb-IIIb in FIG. 1A;

FIGS. 4A and 4B are sectional views for describing a mounted state of the electrical connection sheet illustrated in FIGS. 3A and 3B; and

FIG. 5 is a plan view of an electrical connection sheet according to a third exemplary embodiment of this invention.

### DESCRIPTION OF THE EXEMPLARY EMBODIMENT

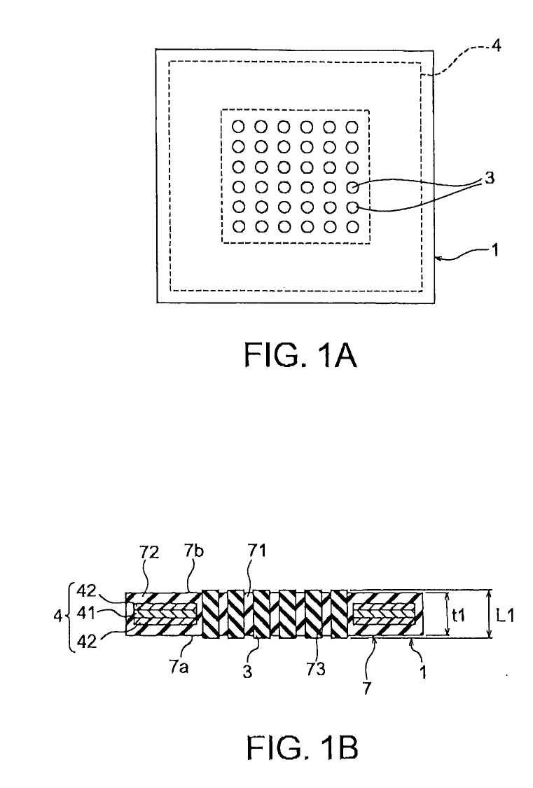

Referring to FIGS. 1A and 1B, description will be made of an electrical connection sheet according to a first exemplary embodiment of this invention. The electrical connection sheet of the type is typically clamped between connection objects and, therefore, may be called a clamped-type electrical connection sheet.

The electrical connection sheet 1 illustrated in FIGS. 1A and 1B comprises a plate-like elastic insulator 7 having first and second principal surfaces 7a and 7b spaced from each other in a predetermined direction, i.e., a thickness direction, a plurality of columnar elastic conductors 3 penetrating a center portion 71 of the elastic insulator 7 to protrude from the first and the second principal surfaces 7a and 7b, and a frame 4 embedded in the elastic insulator 7 at a peripheral portion 72 around the center portion 71 and extending along the peripheral portion 72.

The center portion 71 and the peripheral portion 72 of the elastic insulator 7 have a same size in the predetermined direction and are flush with each other on each of the first and the second principal surfaces 7a and 7b. The elastic insulator 7 is formed by silicone rubber and has a plurality of through holes 73 penetrating the elastic insulator 7 in the predetermined direction and arranged at a constant or uniform pitch in a grid-like pattern. The elastic conductors 3 are inserted through the through holes 73 of the elastic insulator 7, respectively. Therefore, the elastic conductors 3 are also arranged at a constant or uniform pitch in a grid-like pattern.

Each of the elastic conductors 3 is made of an elastic thermosetting material having an elastic modulus greater than that of the elastic insulator 7. The elastic conductor 3 further contains a metal filler such as gold, silver, copper, or nickel and is thereby given conductivity. Under no pressure, the size of the elastic conductor 3 in the predetermined direction, i.e., the length L1 of the elastic conductor 3 is greater than the thickness t1 of the elastic insulator 7.

The frame 4 comprises a square or a rectangular main body 41 having an inner opening or cutout portion in a central portion thereof and made of a thin film material having an extensibility lower than that of the elastic insulator 7, and a primer layer 42 preliminarily formed on each of opposite surfaces of the main body 41 by primer coating or treatment known in the art. Herein, as the thin film material, use may be made of, for example, a metal foil film or a resin thin film such as polyimide and aramide. As a material of the primer layer 42, use may be made of, for example, bisphenol A epoxy resin in IPA solution.

The elastic insulator 7 has elasticity. Therefore, when an external force is applied, the pitch of the elastic conductors 3 would be varied from a desired pitch with the elastic insulator 7 alone. However, the main body 41 of the frame 4 is made of the low-extensibility material, the variation in pitch is suppressed. Due to presence of the primer layer 42 formed on each of the opposite surfaces of the main body 41, the elastic insulator 7 and the frame 4 are firmly adhered to each other and hardly separated from each other even if a shearing force occurs at an interface between the elastic insulator 7 and the frame 4. Further, the primer layer 42 is entirely covered with the elastic insulator 7, a path to ambient air is completely shut off. Therefore, even if ethanol is used in order to remove fat and oil attached to a surface of the electrical connection sheet 1, ethanol is prevented from permeating the interface between the primer layer 42 and the elastic insulator 7. As a result, no separation will be caused so that cleaning is sufficiently performed. In addition, if the electrical connection sheet 1 is stored in a high-humidity environment for a long time, no penetration of humidity occurs so that adhesion is not decreased. Thus, environment resistance is improved.

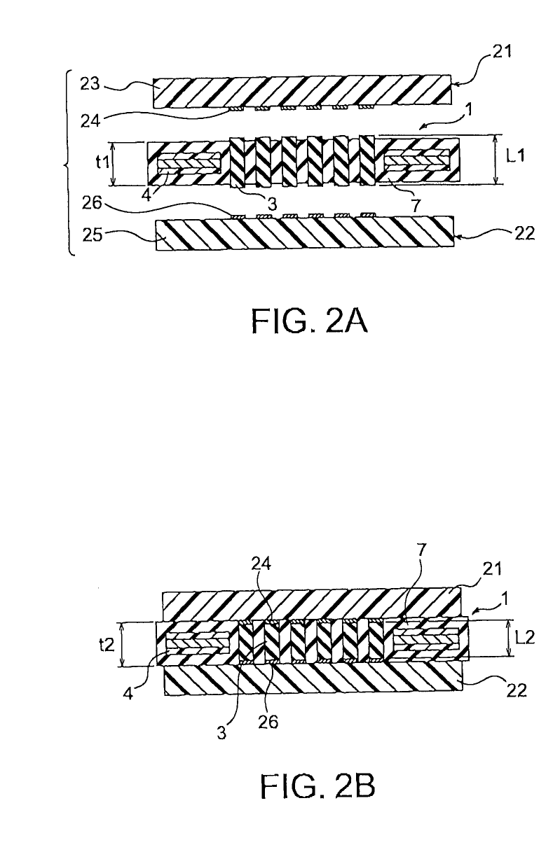

Next referring to FIGS. 2A and 2B, description will be made of a case where the electrical connection sheet 1 is clamped between a connected member 21 and a substrate 22 and mounted.

The connected member 21 comprises a connected main body 23 and a plurality of lands 24 formed on the connected main body 23. On the other hand, the substrate 22 comprises a substrate main body 25 and a plurality of lands 26 formed on the substrate main body 25. The lands 24 and the lands 26 are arranged in a pattern matched with that of the elastic conductors 3 formed on the electrical connection sheet 1.

Upon mounting, the electrical connection sheet 1 is inserted between the connected member 21 and the substrate 22, as illustrated in FIG. 2A. Then, the electrical connection sheet 1 is clamped by the connected member 21 and the substrate 22 so that the lands 24 and the lands 26 are brought into contact with the elastic conductors 3. By pressing means (not shown), the connected member 21 and the substrate 22 with the electrical connection sheet 1 clamped therebetween are pressed. As a consequence, a mounted state illustrated in FIG. 2B is obtained.

Following pressing, the elastic conductors 3 are compressed by the lands 24 and the lands 26 in the predetermined direction. The length of the elastic conductors 3 is shortened from L1 to A2. A volume change at that time exerts a pushing force of pushing the elastic insulator 7 which is softer (i.e., which has a smaller elastic modulus). A resultant force as a combination of the pushing force and a reactive force as a result of compression of the elastic insulator 7 from the thickness t1 into the thickness t2 is applied at a boundary between the elastic insulator 7 and each of a lower surface of the connected main body 23 and an upper surface of the substrate main body 25. As a consequence, the elastic insulator 7 is press-contacted under a strong force with each of the lower surface of the connected main body 23 and the upper surface of the substrate main body 25. Accordingly, an area between every adjacent ones of the elastic conductors 3 is completely sealed without permeation of moisture. Thus, it is possible to prevent occurrence of migration between the elastic conductors 3.

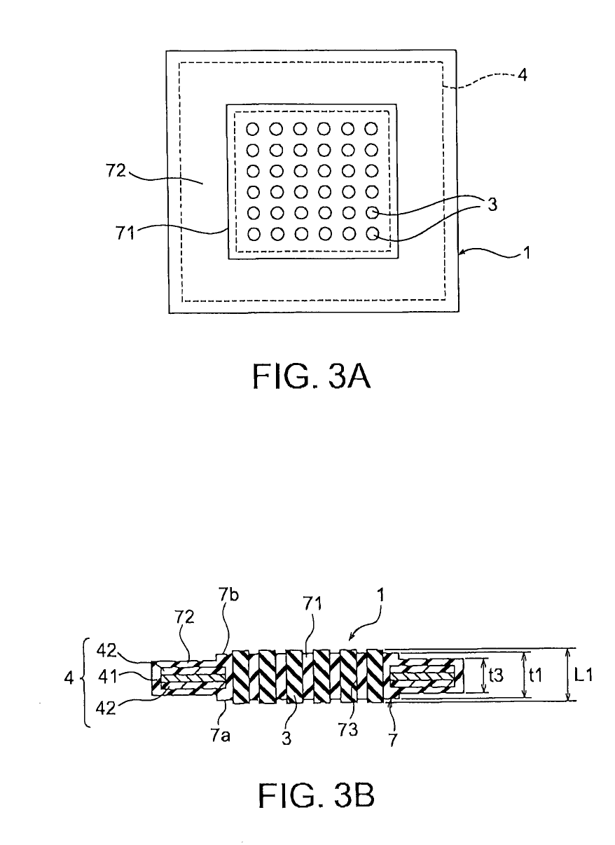

Referring to FIGS. 3A and 3B, description will be made of an electrical connection sheet according to a second exemplary embodiment of this invention. Similar parts are designated by like reference numerals and description thereof will be omitted.

In the electrical connection sheet 1 illustrated in FIGS. 3A and 3B, the elastic insulator 7 has different thicknesses. Specifically, the thickness t3 at the peripheral portion 72 is smaller than the thickness t1 at the center portion 71. The thickness t3 at the peripheral portion 72 is smaller than the thickness t2 of the center portion 71 of the elastic insulator 7 when it is compressed. Further, on each of the first and the second principal surfaces 7a and 7b, a step is formed between the center portion 71 and the peripheral portion 72.

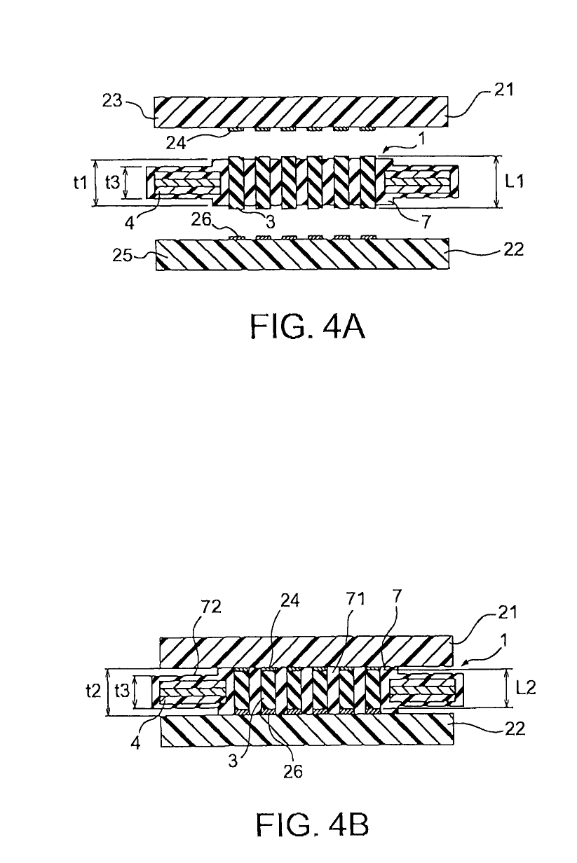

Next referring to FIGS. 4A and 4B, description will be made of a case where the electrical connection sheet 1 is clamped between the connected member 21 and the substrate 22 and mounted.

Upon mounting, the electrical connection sheet 1 is inserted between the connected member 21 and the substrate 22, as illustrated in FIG. 4A. Then, the electrical connection sheet 1 is clamped between the connected member 21 and the substrate 22 in a manner such that the lands 24 and the lands 26 are brought into contact with the elastic conductors 3. By pressing means (not shown), the connected member 21 and the substrate 22 with the electrical connection sheet 1 clamped therebetween are pressed. As a consequence, a mounted state illustrated in FIG. 4B is obtained.

In the mounted state in FIG. 4B, the lower surface of the connected member 21 and the upper surface of the substrate 22 are not contacted with the peripheral portion 72 of the elastic insulator 7. Thus, a pressed area is smaller than that in the mounted state in FIG. 2B. Therefore, a reactive force is reduced by an amount corresponding to reduction in pressed area. Accordingly, it is possible to realize mounting under a low load.

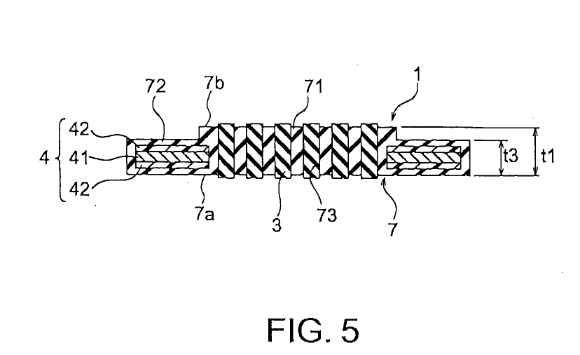

Referring to FIG. 5, description will be made of an electrical connection sheet according to a third exemplary embodiment of this invention. Similar parts are designated by like reference numerals and description thereof will be omitted.

In the electrical connection sheet 1 illustrated in FIG. 5, the thickness t3 at the peripheral portion 72 of the elastic insulator 7 is smaller than the thickness t1 at the center portion 71 of the elastic insulator 7. At the first principal surface 7a, the center portion 71 and the peripheral portion 72 are flush with each other. At the second principal surface 7b, a step is formed between the center portion 71 and the peripheral portion 72. The thickness t3 at the peripheral portion 72 is smaller than the thickness t2 of the center portion 71 of the elastic insulator 7 when it is compressed.

In the electrical connection sheet 1 also, when it is clamped between the connected member 21 and the substrate 22 and then pressed, the reactive force is produced only at the center portion 71. Therefore, an effect similar to that of FIG. 4B is obtained. The structure illustrated in FIG. 5 is advantageous in that the shape of a die used to form the elastic insulator 7 is simplified.

In any of the exemplary embodiments mentioned above, the elastic conductor 3 preferably has a columnar shape in view of production, a balance between pressures applied by electrodes on the substrate and the connected member in the mounted state, and distribution of the pressures to the elastic insulator. The elastic conductors are preferably arranged at an equal interval and in a square or a rectangular matrix pattern.

While the present invention has thus far been described in connection with a few exemplary embodiments thereof, it will readily be possible for those skilled in the art to put this invention into practice in various other manners.

What is claimed is:

1. An electrical connection sheet comprising:
an elastic insulator being of a plate-like and having a first and a second principal surface which are spaced from each other in a predetermined direction, the elastic insulator comprising a center portion and a peripheral portion around the center portion;
a plurality of elastic conductors each being columnar and penetrating the center portion to protrude from the first and the second principal surfaces; and
a frame embedded in the peripheral portion and extending along the peripheral portion.

2. The electrical connection sheet according to claim 1, wherein the frame comprises:
a main body being of a thin film-like and extending between the first and the second principal surfaces and surrounding the elastic conductors collectively; and
a primer layer attached to a surface of the main body.

3. The electrical connection sheet according to claim 2, wherein the primer layer is located between each of the first and the second principal surfaces and the main body.

4. The electrical connection sheet according to claim 2, wherein the main body is made of a material having an extensibility lower than that of the elastic insulator.

5. The electrical connection sheet according to claim 1, wherein the center portion and the peripheral portion are equal in size in the predetermined direction.

6. The electrical connection sheet according to claim 5, wherein the center portion and the peripheral portion are flush with each other on each of the first and the second principal surfaces.

7. The electrical connection sheet according to claim 1, wherein the peripheral portion is smaller in size in the predetermined direction than the center portion.

8. The electrical connection sheet according to claim 7, wherein a step is formed between the center portion and the peripheral portion on each of the first and the second principal surfaces.

9. The electrical connection sheet according to claim 7, wherein the center portion and the peripheral portion are flush with each other on the first principal surface while a step is formed between the center portion and the peripheral portion on the second principal surface.

10. The electrical connection sheet according to claim 1, wherein each of the elastic conductors has an elastic modulus greater than that of the elastic insulator.

11. The electrical connection sheet according to claim 1, wherein each of the elastic conductors has a columnar shape.

12. The electrical connection sheet according to claim 1, wherein the elastic conductors are arranged at an equal interval.
